(19) United States
(12) Patent Application Publication
(10) Pub. No.: US 2003/0069987 A1
(43) Pub. Date: Apr. 10, 2003

(54) Communication method

(76) Inventors: Finnur Sigurdsson, Reykjavik (IS); Fridbjorn Olafsson, Reykjavik (IS); Fridrik Thor Reynisson, Reykjavik (IS); Thorarinn Stefansson, Reykjavik (IS); Thorsteinn H. Steinarsson, Kopavogur (IS)

Correspondence Address: KAPLAN & GILMAN , L.L.P., 900NROUTE 9 NORTH, WOODBRIDGE, NJ, 07095, US

(21) Appl. No.: 09/971,832

(22) Filed: Oct. 5, 2001

(51) Int. Cl. G06F 15/16

(52) U.S. Cl. 709/232; 709/247

(57) ABSTRACT

A communication protocol is presented for improved process efficiency. The protocol maintains a queue for compression of information of a selected quantity of files and selects a file for compression and transmission according to its priority and relative size. The invention protocol also prevents a user from selecting an encoding string length other than the optimum in the case the system is wireless, while allowing a variable string length in a wired device.

### FIELD OF THE INVENTION

The present invention relates to the field of communication, and more particularly to a method for optimizing the compression and transmission of communications.

### BACKGROUND OF THE INVENTION

Wireless communication network devices are proliferating at a rapid rate. Such devices usually comprise a small data-capable phone or handheld computer-like device (i.e. PDA) that permits a user access to a data network such as the Internet. These wireless devices, being comparatively recent developments in a previously wired communication universe, have continued to use communications protocols that are virtually identical to those used for wired telephone devices, personal computers and servers.

One problem of utilizing the existing protocols for wired devices in connecting wireless devices to a wireless communications network, such as the Internet, is the fact that these protocols apply a set of rules which are rendered invalid, or at least inefficient, in the wireless environment. The basic assumptions about a network are different when that network is implemented at least partially by wireless connections.

One example of the above concerns the manner in which network congestion is detected, and the mechanism for correction of such congestion. More specifically, the basic communication protocols utilized for Internet Connectivity are Transport Control Protocol (TCP) and Internet Protocol (IP). These protocols are typically used together, and thus are referred to as the TCP/IP protocol. The TCP/IP protocol is a communication standard that is documented in the Internet Engineering Task Force (IETF) Request for comments (RFC): RFC-793 1981-09, RFC-1072 1988-10, RFC-1693 1994-11, RFC-1146 1990-3, RFC 1323 1992-5.

The TCP frame is embedded within the IP packet, which also includes an identifying header. According to the TCP/IP protocol, an acknowledgement is transmitted from the recipient to the sender of a packet based on the header information. Packet transmission frequently includes subjecting the packet data to a compression algorithm to conserve transmission bandwidth. The compression step consumes an amount of time dependent upon the quantity of data in the packet. However, the sending terminal may continue to send packets at a steady rate that is higher than those packets can be compressed and routed through the network. The TCP/IP protocol handles congestion using a commonly known “leaky bucket” algorithm. In the leaky bucket algorithm, packets can be sent to a router even though its buffer is already full. Packets received by a full buffer are discarded, and thus do not result in a receipt acknowledgement message being transmitted to the sending device.

Since there is a finite time between the transmission of a packet from a sending terminal and the receipt at that sending terminal of an acknowledgement corresponding to that packet, the question arises as to what rate packets should be sent from the sending terminal during the time that such terminal is waiting for an acknowledgement. Second, the sending terminal must be programmed regarding how long to wait for such acknowledgment before presuming that the packet has been lost.

Therefore, it is an object of the present invention to provide a communication protocol that avoids overload of a compression buffer.

It is a further object of the present invention to provide a communication protocol that utilizes the transmission bandwidth of the system efficiently.

These and other objects will become more apparent from the description of the invention to follow.

### SUMMARY OF THE INVENTION

The invention disclosed herein provides an improved communication method that maximizes the utilization of transmission bandwidth for wireless devices. A first aspect of the invention analyzes the number of information packets in a communication buffer awaiting compression and controls the number of packets that are sent to that buffer accordingly. A further aspect of the invention employs rules relating to message importance in relation to system congestion to improve transmission efficiency. The system applies established rules to prioritize messages or files for efficient handling. A final aspect of the invention recognizes that a user of the system may desire to reset the number of information bits for encoding, but the system does not permit such a reset if the intended number is in conflict with efficient wireless processing.

### BRIEF DESCRIPTION OF THE DRAWINGS

FIG. 1 is a schematic diagram of a wireless communication system utilizing the present invention.

FIG. 2A is a flowchart of a queue control process of the present invention.

FIG. 2B is a flowchart of a file handling and compression method of the present invention.

FIG. 3 is a flowchart of a discretionary size override process of the present invention.

### DETAILED DESCRIPTION OF THE INVENTION

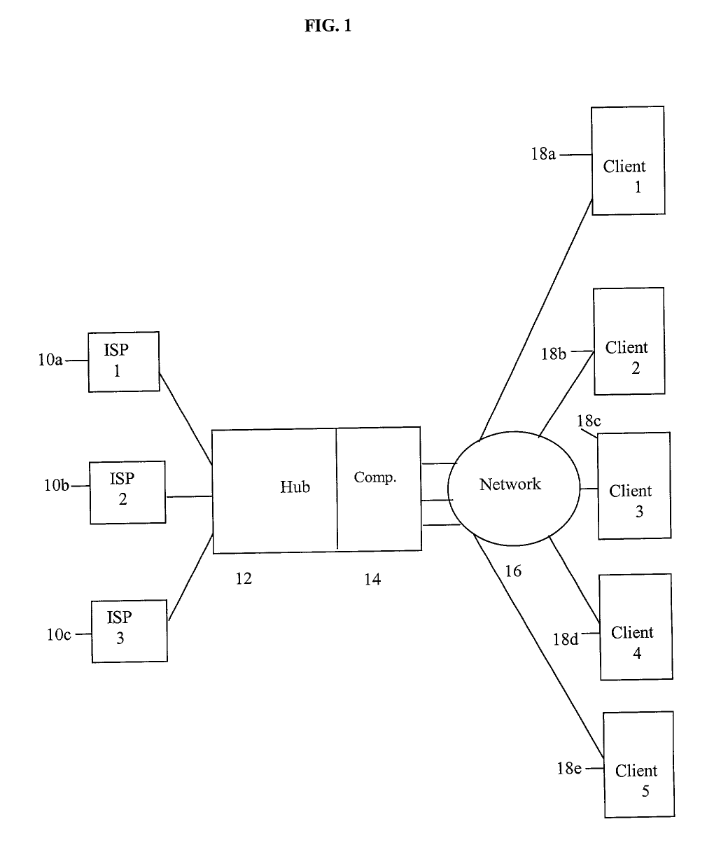

According to the invention disclosed, FIG. 1 illustrates a communication system that utilizes wireless client devices for sending and receiving. Whereas the invention deals with transmission and reception of messages via TCP/IP packets, the sending portion of the system is not portrayed. A plurality of sources, which may be a server, a computer, or other storage facility, referred to below as Internet service providers (ISPs) 10a, 10b, and 10c are adapted for transmitting voice and data messages to a processing hub 12 where a computer or server (not shown) coordinates packet receipt and deployment. Hub 12 is configured with a plurality of RAM segments that act as buffers to hold data in queue for processing. A primary function of hub 12 is to act as a buffer to hold packets that it receives and then pass the packets to compression engine 14, which employs an algorithm to compress the data in the communication portion of each packet without disturbing the identification in the packet header. As is known to those skilled in the art, a compression operation involves a certain amount of time that varies according to the algorithm employed and according to the amount of data being compressed.

At the completion of the compression step, hub 12 and compression engine 14 send the packet on to network 16, for example the Internet. All through this process, the packet header maintains information for sorting the individual packets and assembling and transmitting the entire message to the intended receiving client device 18a-18e. Thus, a message originating from a source, e.g. ISPs 10a-10c, is delivered to the predetermined one of clients 18a-18e for which the message is intended. The transmission from network 16 to clients 18a-18e may be either by optical fiber, electric hardwired or wireless means.

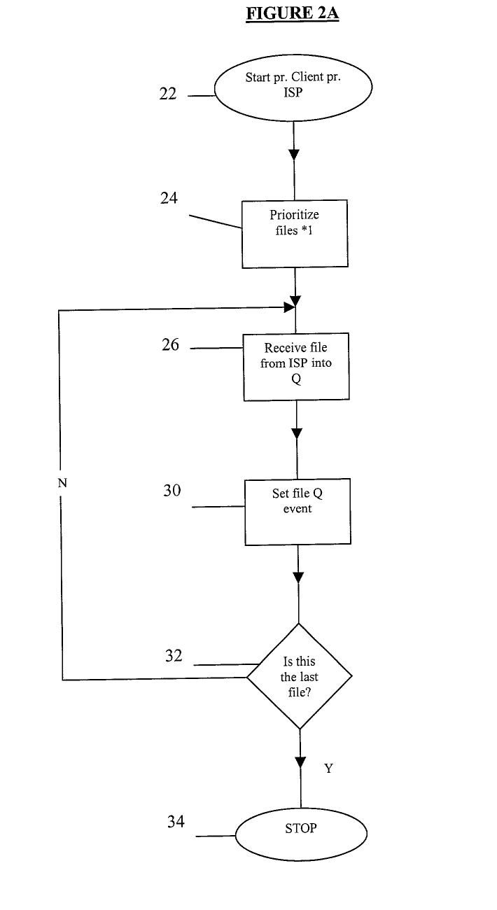

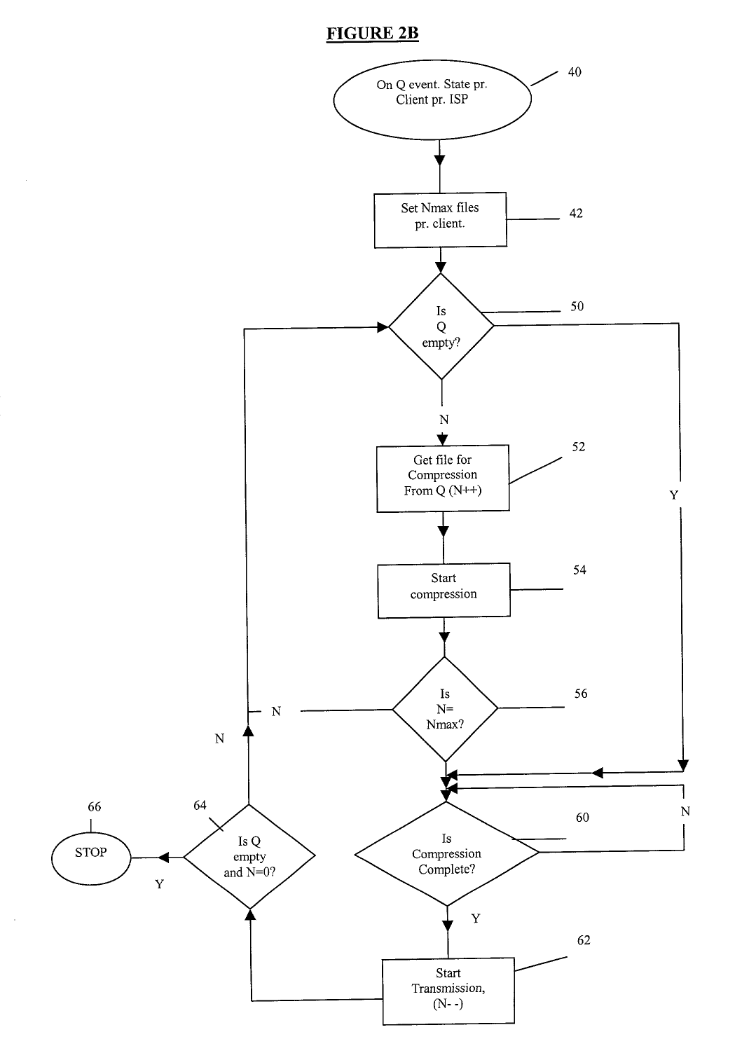

Referring now to FIG. 2A, a pair of parallel flowcharts representing substantially simultaneous processing is illustrated. Process initiation occurs at step 22, whereupon the files in memory are prioritized at step 24. The present invention provides for placing the files in an arbitrary priority order before transmission in order to achieve optimum bandwidth utilization. Prioritization is established based on information in the packet headers without any need to move the full file. The rules for file prioritization are optional according to the communication system design, possibly selecting first file-in or shortest file handling or a file designated as having particular significance to be transmitted first. The prioritized files are received into the queue from the ISP at step 26, and a queue event is triggered at step 30. Step 30 also serves to begin the process portrayed in FIG. 2B at step 40.

Returning to FIG. 2A, step 32 determines if the file being processed represents the last file. If this is the last file, the process stops at step 34. If this is not the last file, the process cycles in a loop to return to step 26 and proceed as described above.

Referring now to FIG. 2B, starting step 40 moves to step 42 to set the maximum number of files N able to be received in the queue for each memory buffer and from each ISP. With the buffer queue size established as Nₘₐₓ, the system next determines whether the queue is empty at step 50. If the queue is empty, the process moves to step 60. If the queue is not empty, a file is obtained from the queue for processing, e.g., compression, at step 52 and the number of files in the queue is adjusted accordingly. Compression or other processing is begun at step 54, and the system determines whether the number of files N in the queue is equal to the maximum number Nₘₐₓ at step 56. If so, the system determines at step 60 whether compression has been completed. If not, the system returns to step 50. If step 60 determines that compression is complete, transmission is started at step 62 and the number of files N in queue is decremented accordingly. If not, a return loop to the top of step 60 repeats the question. After transmission the system determines whether the queue is empty and no compression is ongoing at step 64. If empty, the process is stopped at step 66. If the queue is not empty, the process reverts to step 50. It should be noted that compression is an example of a type of processing that can take place during the file manipulation stage. Other types of processing can take place as well, either in addition to or instead of the compression. Examples of such processing can be file reduction, bit manipulation and any kind of content manipulation on the files.

According to the process described above, the system maintains a substantially stable buffer size and passes files at an efficient rate. Further, by enabling the flowchart process shown in FIG. 2A to operate in parallel time with the steps shown in FIG. 2B, processing proceeds at an efficient speed.

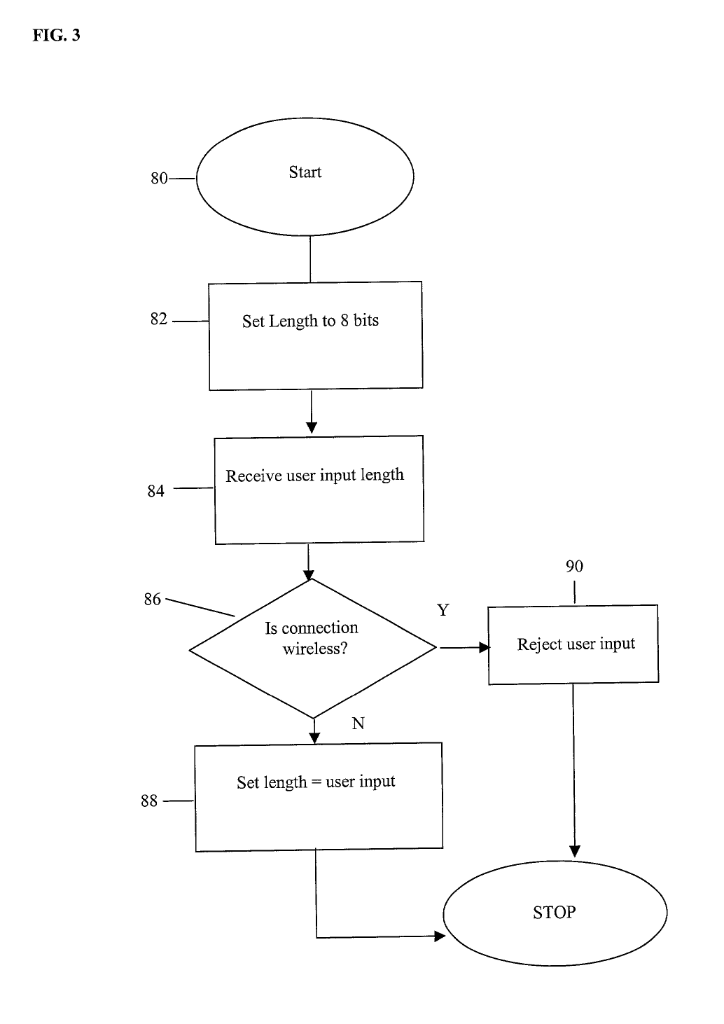

Referring now to FIG. 3, the invention recognizes that an optimum number of bits, for example 8 bits, is appropriate for encoding in a wireless communication link, while another number of bits, for example 7 bits, may be reasonable for a wired system. After the system starts at step 80, a user of the system is permitted to change the default length of the encoding string at step 82, and the user's input string length is received in step 84. At decision point 86, the system determines whether the connection on which communication is occurring is wireless. If the connection is wired, the user selected string length is input at step 88. If the connection is wireless, the user selected string length is rejected at step 90 as potentially slowing the process of the system. When the system either accepts and inputs or rejects the selected user string length, the system stops.

While the present invention is described with respect to specific aspects and embodiments thereof, it is recognized that various modifications and variations thereof may be made without departing from the scope and spirit of the invention, which is more clearly understood by reference to the claims appended hereto.

What is claimed is:

1. A communication method comprising the steps of:
(a) downloading identifying information about each of a series of files from a storage facility to a processor;
(b) placing the files in a priority order according to the identifying information and established rules;
(c) downloading a first file in the priority;
(d) processing the file; and
(e) transmitting the processed file to a remote location while remaining ones of the files are being downloaded.

2. The method of claim 1 wherein the step of processing comprises the step of determining whether processing is complete.

3. The method of claim 2 wherein the files are processed from a processing queue, and the queue is limited to a maximum size of N files.

4. The method of claim 3 wherein the steps of transmitting, processing, and downloading are accomplished substantially simultaneously.

5. The method of claim 1 wherein the step of processing comprises, compressing the file.

6. The method of claim 1, further comprising the step of placing the files in a queue and wherein the queue is limited to a maximum size of N files.

7. The method of claim 1, further comprising the step of determining whether a queue is empty prior to beginning the step of processing.

8. A communication method comprising the steps of:
(a) setting a number of files acceptable from each one of a plurality of sources;
(b) receiving a new file from a source into a buffer;
(c) determining whether a total number of files in the buffer is equal to the set number;
(d) if the total number of files in the buffer is equal to the set number, compressing a file; and
(e) transmitting the compressed file.

9. The communication method described in claim 8, further comprising the steps of:
a. if the total number of files in the buffer is not equal to the set number receiving an additional new file from the source; and
b. if the total number of files now in the buffer is equal to the set number, compressing a file; and
c. transmitting the compressed file.

10. A communication method comprising the steps of:
a. setting an encoding length for a communication at eight bits;
b. accepting a user input length for the encoding length;
c. determining whether the connection is wireless;
d. if the connection is wireless, rejecting the user input length; and
e. if the communication is not wireless, setting the encoding length equal to the user input length.

11. The communication method as described in claim 1, further comprising the steps of:
a. setting an encoding length for a communication at eight bits;
b. accepting a user input length for the encoding length;
c. determining whether the connection is wireless;
d. if the connection is wireless, rejecting the user input length; and
e. if the communication is not wireless, setting the encoding length equal to the user input length.

12. The communication method as described in claim 8, further comprising the steps of:
a. setting an encoding length for a communication at eight bits;
b. accepting a user input length for the encoding length;
c. determining whether the connection is wireless;
d. if the connection is wireless, rejecting the user input length; and
e. if the communication is not wireless, setting the encoding length equal to the user input length.

13. The method described in claim 1, wherein the step of downloading a first file comprises receiving the first file from an ISP and the step of downloading remaining ones of the files comprises receiving remaining ones of the files from the ISP.
